(19) United States
(12) Patent Application Publication
(10) Pub. No.: US 2014/0020514 A1
(43) Pub. Date: Jan. 23, 2014

(54) INLINE HANDLE TOOL WITH MID-TOOL CABLE-EXIT

(71) Applicant: Automotive Industrial Marketing Corp. dba AIMCO, Portland, OR (US)

(72) Inventors: Leonard Demchak, Streetsboro, OH (US); Christopher Landon, Portland, OR (US); Michael Juliano, Chardon, OH (US)

(21) Appl. No.: 13/914,359

(22) Filed: Jun. 10, 2013

Related U.S. Application Data
(60) Provisional application No. 61/673,211, filed on Jul. 18, 2012.

(51) Int. Cl. B25B 21/00; B25F 5/02

(52) U.S. Cl. CPC B25B 21/00; B25F 5/02
USPC 81/57.13; 81/54; 81/57.11

(57) ABSTRACT

Disclosed herein are powered torque tools that may be used in assembly operations in confined spaces, such as doors-on automotive assembly operations. In various embodiments, the torque tools include an elongated housing having a proximal end and a distal end, wherein the proximal end includes a gripping handle. The disclosed torque tools also may include a drive element disposed in the distal end portion and adapted to rotatably engage a threaded fastener, a gear assembly operatively connected within the housing and operatively coupled to the drive element, a drive motor disposed within the gripping handle, and a cable-exit extending from the housing and positioned between the gripping handle and the distal end portion, wherein the cable-exit is configured to electrically couple the motor to a control cable.

### CROSS REFERENCE TO RELATED APPLICATIONS

The present application claims priority to U.S. Patent Application No. 61/673,211, filed Jul. 18, 2012, entitled “INLINE HANDLE TOOL WITH SIDE CABLE EXIT,” the entire disclosure of which is hereby incorporated by reference in its entirety.

### TECHNICAL FIELD

Embodiments relate to powered torque tools for use in assembly applications.

### BACKGROUND

The present disclosure relates to powered torque tools for applying torque to fasteners, such as threaded nuts and bolts. Powered torque tools conventionally include a drive motor drivingly connected to a gear train, which in turn applies torque to a fastener through an engaging element such as a socket or tool bit.

Such powered tools are often used in the assembly of heavy machinery and vehicles, such as automobiles, trucks, aircraft, watercraft, and the like, and such assembly operations often require the use of powered torque tools in applications involving space constraints. Frequently, the size of the powered torque tool and/or the placement of the corresponding controller cable may impinge on various vehicle parts during use, making the powered torque tool difficult for the operator to manage.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A, 1B, and 1C illustrate three examples of doors-on automobile assembly applications;

FIGS. 2A, 2B, 2C, and 2D illustrate four examples of prior art powered torque tools, including a lever-style tool with a rear-exit cable (FIG. 2A), a pistol-style tool with a top-exit cable (FIG. 2B), a pistol-style tool with a rear-exit cable (FIG. 2C), and a pistol-style tool with a bottom-exit cable (FIG. 2D);

FIGS. 3A, 3B, 3C, and 3D illustrate four views of a powered torque tool with a mid-tool cable-exit, including a perspective view (FIG. 3A), a side view (FIG. 3B), a top view (FIG. 3C), and a bottom view (FIG. 3D);

FIG. 4 illustrates a longitudinal cross-sectional view of the powered torque tool of FIG. 3; and

FIGS. 5A, 5B, 5C, and 5D illustrate a side view of the powered torque tool of FIG. 3 (FIG. 5A) that illustrates the planes of the cross-sectional views shown in FIGS. 5B, 5C, and 5D, all in accordance with various embodiments.

### DETAILED DESCRIPTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Disclosed herein in various embodiments are powered tools, such as powered torque tools, that may be used for assembly applications that are carried out in low clearance conditions. In various embodiments, the powered torque tools may have a tool body that has a proximal end and a distal end, with the socket or tool bit at the distal end and the gripping handle at the proximal end. In various embodiments, a cable-exit may be positioned approximately mid-way along the tool body, and may extend away from the tool body in front of (e.g. distal to) the operator's hand. Such a configuration may allow for a shorter tool body, which reduces clearance issues, without sacrificing ergonomics or leverage for the operator. Additionally, in various embodiments, such a configuration may allow the powered torque tool to be balanced about the cable-exit, and may permit the cable to be directed in such a way that it does not interfere with the use of the tool in confined spaces.

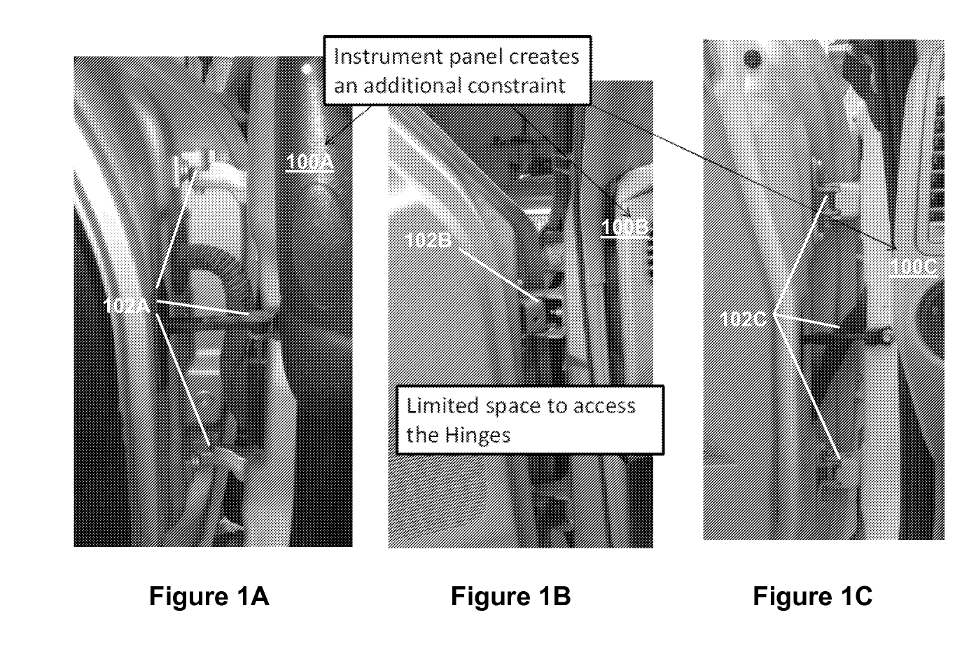

In the assembly of certain heavy machinery and vehicles, such as automobiles, trucks, watercraft, and aircraft, certain assembly steps may be carried out in small spaces, where there is limited room for an operator to manipulate a powered torque tool. An example of such a low clearance assembly step is the attachment of an automobile door to a hinge. This difficult fastening operation is frequently referred to as a “doors-on” operation, and it offers limited space within which to attach the bolts or other fasteners, particularly when the automobile instrument panel (e.g., the dashboard) is installed prior to the doors and interferes with bolt access. FIGS. 1A, 1B, and 1C illustrate three examples of doors-on automobile assembly applications. As can be seen in FIGS. 1A-1C, prior installation of the instrument panel 100A, 100B, 100C can make access to the hinges 102A, 102B, 102C difficult. Although this access constraint is illustrated herein in an automotive doors-on assembly application, the same concerns about constraint occur in other automotive assembly operations, as well in non-automotive fastening operations.

In a constrained space, such as an automotive doors-on assembly operation, the overall length of the powered torque tool is important in determining clearance. In existing, prior art torque tools, the cable that runs between the controller and the torque tool typically couples to either the proximal end of the tool, behind the operator's hand, or to the bottom of the gripping handle, below the operator's hand. Either of these cable placements may add effective length to the tool, as the cable typically has about a four-foot bend radius. Additionally, these cable placements may position the cable in the way of the operator, impinging on the instrument panel during a doors-on assembly step and making the torque tool difficult to manage.

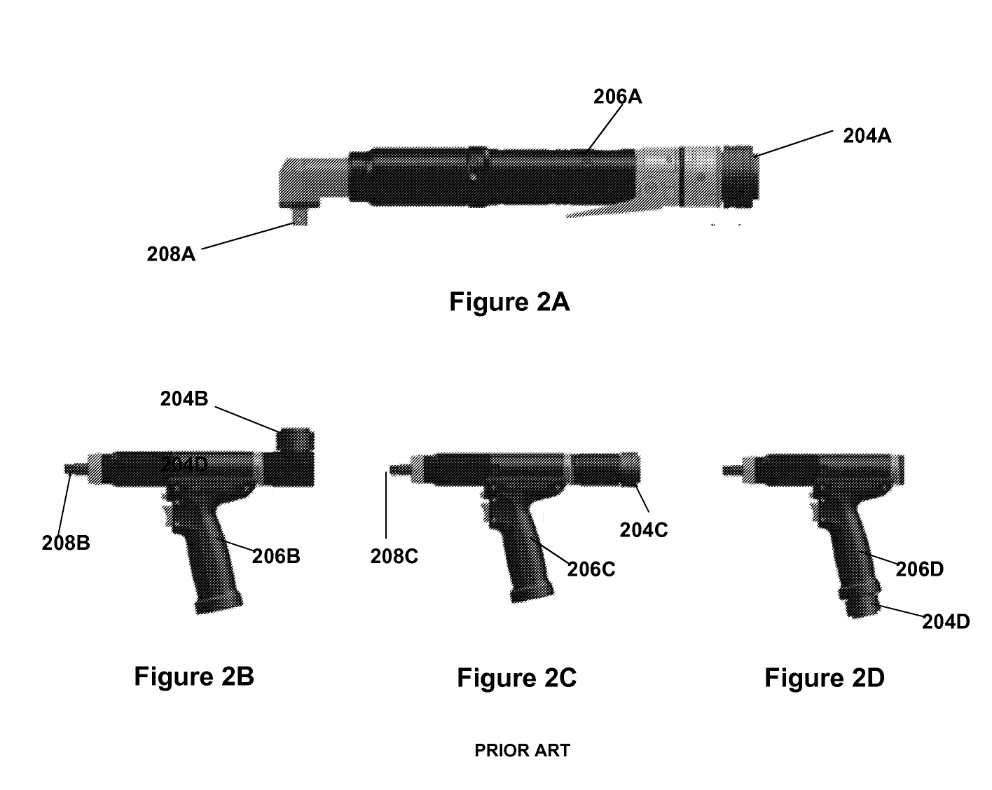

FIGS. 2A, 2B, 2C, and 2D illustrate four examples of prior art powered torque tools, including a lever-style tool with a rear-exit cable (FIG. 2A), a pistol-style tool with a top-exit cable (FIG. 2B), a pistol-style tool with a rear-exit cable (FIG. 2C), and a pistol-style tool with a bottom-exit cable (FIG. 2D). Lever-style torque tools, such as the one illustrated in FIG. 2A, typically position the cable-exit 204A at the rear of the tool, opposite the drive element 208A (e.g., a socket, gearhead, or tool bit) behind the operator's hand as it grips the gripping handle 206A. This design may be awkward to use in small spaces due to the length of the device.

Other power tools may be pistol-style tools, on which the cable typically exits the rear of the tool or the gripping handle. For example, the top-exit cable tool illustrated in FIG. 2B positions the cable-exit 204B at the rear of the tool (e.g., at the proximal end), opposite the drive element 208B, and behind the gripping handle 206B. The rear-exit cable tool illustrated in FIG. 2C also positions the cable-exit 204C at the rear of the tool, opposite the drive element 208C, and behind the gripping handle 206C. The bottom exit cable tool illustrated in FIG. 2D positions the cable-exit 204D at the bottom of the tool at the base of the gripping handle 206D.

The pistol-style designs of FIGS. 2B-2D reduce the overall length of the torque tool as compared to the lever-style tool of FIG. 2A, but they place the cable in an awkward position during use. Additionally, the reduced distance between the handle and the drive element 208 may reduce leverage and increase the torque force that must be countered by the operator. Furthermore, the gripping handle of the pistol-style tools is not in the correct ergonomic position for the operator, which may force the operator to bend over during use in order to align the tool with the application, and which may create stress on the operator's wrist during use. Because of these shortcomings, an operator sometimes will instead hold the tool by the motor portion, upside down, or may use two hands to hold and activate the torque tool.

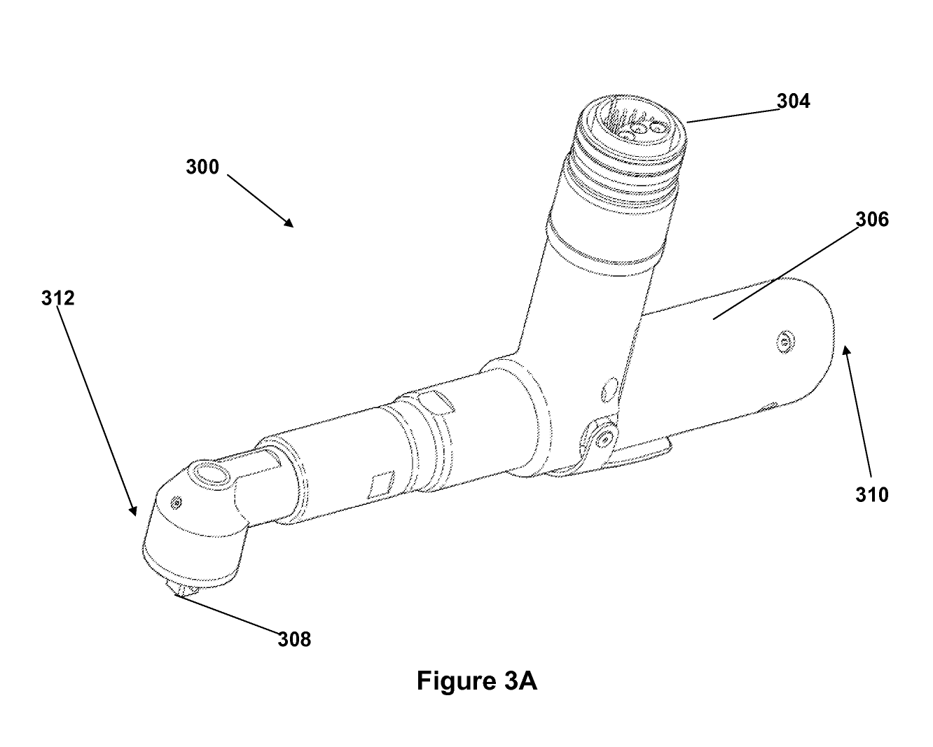

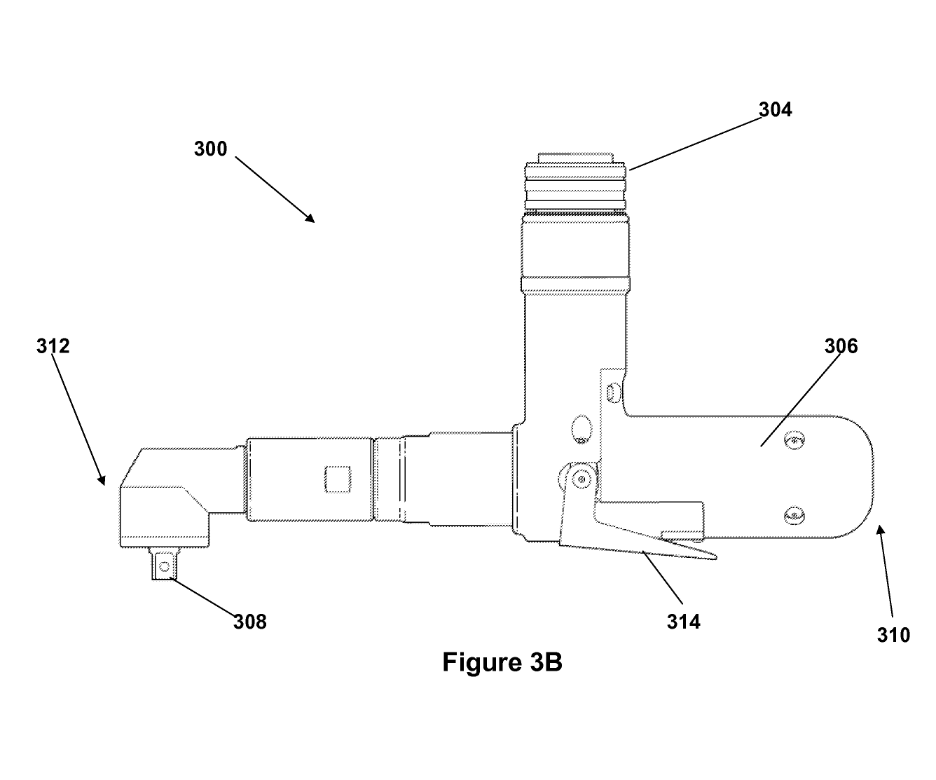

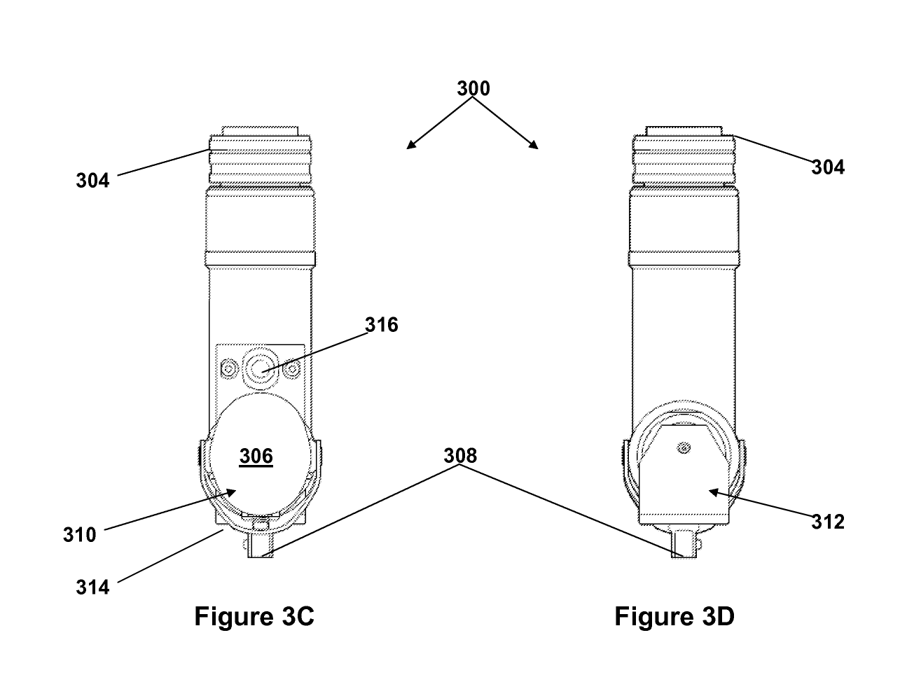

By contrast, the powered torque tools of the present disclosure provide superior ergonomics, better cable management, and a shorter tool length without sacrificing leverage. FIGS. 3A, 3B, 3C, and 3D illustrate four views of an embodiment of a powered torque tool with a mid-tool cable-exit, including a perspective view (FIG. 3A), a side view (FIG. 3B), a top view (FIG. 3C), and a bottom view (FIG. 3D). In various embodiments, because the cable-exit 304 may be positioned on the torque tool approximately midway between the proximal end 310 and the distal end 312 of the torque tool 300, the gripping handle 306 may be positioned behind (e.g., proximal to) cable-exit 304. In various embodiments, this arrangement may permit the overall proximal-to-distal length of torque tool 300 to be reduced relative to the prior art torque tools, which may allow use of the torque tool in more constrained applications, such as door-on assembly steps. For example, in specific, non-limiting examples, the overall length of the disclosed torque tools may be reduced from the typical length of 11-12 inches for prior art torque tools, to an overall length of approximately 8-9.5 inches, for example, about 9.2, 9.0, 8.8, 8.6, or 8.4 inches in length. Additionally, for prior art tools, the measurement of 11-12 inches does not include the cable, strain relief device, or cable bend radius, all of which add substantially to the effective length of the device. By contrast, the placement of cable-exit 304 on the torque tools disclosed herein does not add to the overall length of torque tool, making the size difference between the disclosed torque tools and the prior art tools even greater.

In various embodiments, this overall reduction in tool length may be accomplished while also reducing the torque reaction (e.g., recoil) from the tool relative to pistol-style tools. Because the operator's hand is positioned farther away from the drive element 308 in various embodiments, it affords the operator more leverage when operating the torque tool. This leverage is further improved in various embodiments by positioning the cable-exit 304 in front of the operator's hand. Additionally, by positioning gripping handle 306 inline with the body of torque tool 300, less stress is put on the wrist of the user in various embodiments.

Moreover, mid-tool cable-exit 304 may be used with a spring balancer in some embodiments, which may permit torque tool 300 to hang naturally near its center of gravity, thus permitting the cable to be controlled by the balancer. In various embodiments, the position of cable-exit 304 in front of gripping handle 306 also may facilitate cable management by the operator. This may be especially beneficial in applications in which one plane has length constraints, but the plane at 90 degrees is free from obstruction. In a doors-on assembly operation, the plane free from obstruction would be a vertical plane, for instance.

Although cable-exit 304 is shown as being positioned at the top of the body of torque tool 300, and exits the body of torque tool 300 at approximately 90° degrees relative to the longitudinal axis of torque tool 300, in some embodiments, cable-exit 304 may instead be configured to exit at approximately 70-110° relative to the longitudinal axis, and may extend from the top or from a side of torque tool 300. Likewise, although drive element 308 is illustrated as being angled downward, in other embodiments, drive element 308 may be configured to be oriented in any degree of rotation about the longitudinal axis of torque tool 300, such as upward, at a 45° angle, or to either side, or it may employ a straight output and point straight ahead and away from distal tip 312. In some embodiments, a socket, an external gear assembly, or a coupler may be used in place of or together with the illustrated tool bit.

In various embodiments, control elements may be positioned on torque tool 300 so that they may be actuated easily and intuitively when the operator's hand is in any of a number of positions. As can be seen best in FIGS. 3B and 3C, in various embodiments, an activation lever 314 or switch member may be positioned opposite of cable-exit 304 and adjacent a bottom surface of gripping handle 306 such that it may be activated with either hand and with the hand in any position within 360° of rotation about the gripping handle 306. As may be best seen in FIG. 3C, a mode selection element 316, such as a button or switch, may be positioned at the base of cable-exit 304 adjacent gripping handle 306 in various embodiments, which positioning may enable an operator to easily switch between modes by activating the mode button with a thumb or finger, depending on the orientation of the operator's hand. In some embodiments, one or more status or indicator lights also may be positioned on or about cable-exit 304.

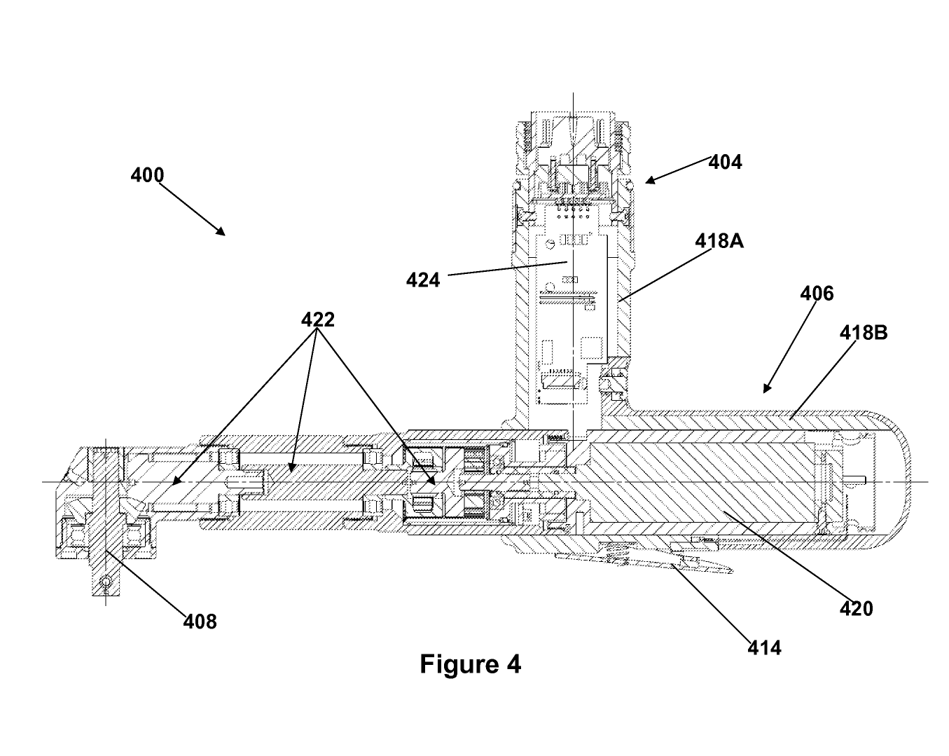

FIG. 4 illustrates a longitudinal cross-sectional view of the powered torque tool of FIG. 3. As can be seen in FIG. 4, the exterior of torque tool 400 may include a two-part composite housing 418A, 418B that forms the exterior portion of gripping handle 406 and cable-exit 404. In various embodiments, a drive motor 420 may be positioned within gripping handle 406 and may be configured to drive a gear train assembly 422 that is operatively connected within in the body of torque tool 400, and which in turn is configured to apply torque to drive element 408. In various embodiments, activation lever 414 may couple to composite housing member 418B, and may be configured to control the operation of drive motor 420. In some embodiments, cable-exit 404 may house a cable connector/light panel/switch unit 424, which in specific, non-limiting examples may be a single module.

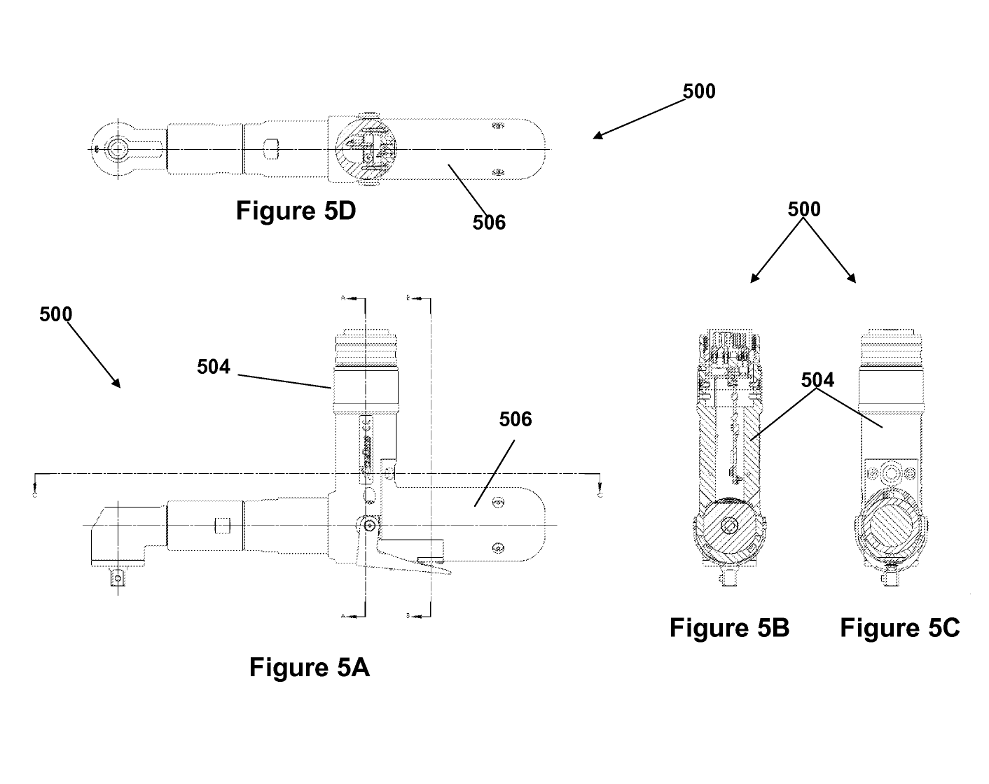

FIGS. 5A, 5B, 5C, and 5D illustrate a side view of the powered torque tool of FIG. 3 (FIG. 5A) that illustrates the planes of the cross-sectional views shown in FIGS. 5B, 5C, and 5D, all in accordance with various embodiments.

Specifically, FIG. 5B illustrates a cross section through cable-exit 504 at plane A-A; FIG. 5C illustrates a cross section through gripping handle 506 at plane B-B, just proximal to cable-exit 504; and FIG. 5D illustrates a transverse cross section through the base of cable-exit 504 at plane C-C.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A torque tool comprising:
an elongated housing having a proximal end and a distal end;
a drivetrain disposed within the housing and adapted to provide torque to a threaded fastener;
a gripping handle disposed at the proximal end;
a cable-exit adapted to couple to a control cable, wherein the cable-exit extends from the elongated housing between the gripping handle and the distal end.

2. The torque tool of claim 1, wherein the wherein the cable-exit extends from the elongated housing at an angle of 70-110° relative to a longitudinal axis of the elongated housing.

3. The torque tool of claim 1, wherein the wherein the cable-exit extends from the elongated housing at an angle substantially perpendicular to the elongated housing.

4. The torque tool of claim 1, wherein a portion of the drivetrain is disposed within the gripping handle.

5. The torque tool of claim 1, wherein the gripping handle extends inline with the elongated housing.

6. The torque tool of claim 1, wherein the cable exit extends from the elongated housing at the approximate midpoint between the proximal end and the distal end.

7. The torque tool of claim 1, further comprising an activation element operatively coupled to the drivetrain and disposed on the housing adjacent the gripping handle.

8. The torque tool of claim 1, further comprising a mode switch operatively coupled to the drivetrain and disposed on the cable-exit adjacent the gripping handle.

9. The torque tool of claim 1, wherein the distance between the proximal end and the distal end is less than about 9.5 inches.

10. A torque tool comprising:
a housing, wherein the housing is elongated and comprises a proximal end portion and a distal end portion, wherein the proximal end portion of the housing comprises a gripping handle;
a drive element disposed in the distal end portion and adapted to rotatably engage a threaded fastener;
a gear assembly operatively connected within the housing and operatively coupled to the drive element;
a drive motor disposed within the gripping handle, wherein the drive motor is operatively coupled to and adapted to provide rotational torque to the gear assembly;
a cable-exit extending from the housing and positioned between the gripping handle and the distal end portion, wherein the cable-exit is configured to electrically couple the motor to a control cable.

11. The torque tool of claim 10, wherein the cable-exit extends from the housing approximately mid-way between the proximal end portion and the distal end portion of the housing.

12. The torque tool of claim 10, wherein the control cable is adapted to supply power to the motor.

13. The torque tool of claim 10, wherein the gripping handle is substantially parallel to a longitudinal axis of the housing.

14. The torque tool of claim 10, wherein the drive element comprises a tool bit, a socket, or a gearhead.

15. The torque tool of claim 10, wherein the drive element as oriented between 90° and 180° relative to a longitudinal axis of the housing.

16. The torque tool of claim 15, wherein the drive element as oriented at 90° relative to the longitudinal axis of the housing.

17. The torque tool of claim 15, wherein the drive element as oriented at 180° relative to the longitudinal axis of the housing.

18. The torque tool of claim 10, further comprising an activation element, wherein the activation element is positioned on the housing adjacent to the gripping handle and opposite the cable-exit.

19. The torque tool of claim 18, wherein the activation element comprises a switch.

20. The torque tool of claim 18, wherein the activation element comprises a lever.

21. The torque tool of claim 10, further comprising a mode selection element disposed on the cable-exit adjacent the gripping handle.
